(19) United States
(12) Patent Application Publication
(10) Pub. No.: US 2025/0350851 A1
(43) Pub. Date: Nov. 13, 2025

(54) SYSTEMS AND METHODS FOR ADJUSTING COLOR BALANCE AND EXPOSURE ACROSS MULTIPLE CAMERAS IN A MULTl-CAMERA SYSTEM

(71) Applicant: HUDDLY AS, Oslo (NO)

(72) Inventors: Jan Tore KORNELIUSSEN, Oslo (NO); Babak MOUSSAKHANI, Billingstad (NO); Eirik SUNDET, Sandvika (NO); Espen Woien OLSEN, Oslo (NO); Vegar AABREK, Oslo (NO); Simen BERG-HANSEN, Hosle (NO)

(73) Assignee: HUDDLY AS, Oslo (NO)

(21) Appl. No.: 19/280,475

(22) Filed: Jul. 25, 2025

Related U.S. Application Data
(63) Continuation of application No. PCT/IB2024/050759, filed on Jan. 26, 2024.
(60) Provisional application No. 63/441,645, filed on Jan. 27, 2023.
(60) Provisional application No. 63/441,646, filed on Jan. 27, 2023.

(51) Int. Cl. H04N 23/88; H04N 23/66; H04N 23/73

(52) U.S. Cl. CPC H04N 23/88; H04N 23/66; H04N 23/73

(57) ABSTRACT

Consistent with disclosed embodiments, systems and methods for adjusting color balance across multiple cameras. Embodiments of the present disclosure may include a color balance unit. The color balance unit may include at least one processor programmed to receive at least one white point candidate and a spatial distribution from a first camera among a plurality of cameras and at least one white point candidate and a spatial distribution from a second camera among the plurality of cameras. The at least one processor may be configured to compare the at least one white point candidate and the spatial distribution received from the first camera with the at least one white point candidate and the spatial distribution received from the second camera and determine, based on the comparing, a target color balance level for use by one or more of the plurality of cameras in adjusting a color balance setting. The at least one processor may be further programmed to distribute the target color balance level to the one or more of the plurality of cameras.

### CROSS-REFERENCE TO RELATED APPLICATIONS

This application claims the benefit of priority of U.S. Provisional Application No. 63/441,645, filed Jan. 27, 2023, and U.S. Provisional Application No. 63/441,646, filed Jan. 27, 2023. The contents of each of the above-referenced applications is incorporated herein by reference in its entirety.

### TECHNICAL FIELD AND BACKGROUND

The present disclosure relates generally to camera systems and, more specifically, to systems and methods for adjusting color balance and/or light exposure across multiple cameras.

In traditional videoconferencing systems, color balance (or white balance) and/or light exposure are often controlled by software components running on each video camera. The color and exposure of each video stream output by each video camera is typically adjusted based on particular standards and the environment of each camera. But differences in color and/or exposure between cameras may create disruptions in a videoconferencing experience when toggling between views or composing multiple views, breaking the continuity of a video stream displayed in the videoconference.

In broadcast settings, multi-camera productions are often manually set up with fixed color and/or exposure settings prior to streaming or post-production. However, such fixed color and/or exposure settings may not apply to, for example, videoconferencing systems. Existing systems and methods for seamless color and exposure in multi-camera setups may require manual calibration with sometimes specialized calibration targets, carefully chosen matched camera units or models, controlled studio surroundings, and post-production adjustment. Calibration is therefore a requirement for good synchronization of color and white balance (and exposure balance) in a setup with different types of cameras.

Further, in the context of stitching many still photos taken from a single viewpoint, the adaptation of color and intensities to avoid seams and color shading in the final image is often done after the images have been captured. Images are often adjusted in pairs to minimize differences.

Synchronizing automatic white balance (or color balance) between unequal cameras is challenging due to production unit, batch, and model variations between cameras. A low-level white balance setting for a particular camera may not appear similar on another camera, even when viewing the same object or environment.

Similarly, synchronizing light exposure between cameras in a multi-camera system is challenging when each camera in the system is running auto-exposure on its own. Algorithms controlling exposure in a camera (or video output) must be dynamic due to changing lighting conditions, and different lighting conditions within a single meeting environment between different cameras of a multi-camera system may break the continuity of a video stream displayed in the videoconference.

Thus, there is a need for a multi-camera system or method for calibrating and/or (continuously) synchronizing the color balance (or white balance) and/or exposure of each camera relative to each other camera of the multi-camera system such that the videoconferencing experience is seamless.

### SUMMARY

Disclosed embodiments may address one or more of these challenges. The disclosed cameras and camera systems may include a smart camera or multi-camera system that understands the dynamics of the meeting room participants (e.g., using artificial intelligence (AI), such as trained networks) and provides an engaging experience to far end or remote participants based on, for example, the number of people in the room, who is speaking, who is listening, and where attendees are focusing their attention. Examples of meeting rooms or meeting environments may include, but are not limited to, meeting rooms, boardrooms, classrooms, lecture halls, meeting spaces, and the like.

Embodiments of the present disclosure provide a multi-camera system for adjusting color balance across multiple cameras. The system may comprise a color balance unit, and the color balance unit may include at least one processor. The color balance unit may be located on board one or more cameras in the multi-camera system or may be located remote relative to one or more cameras in the multi-camera system. The at least one processor may be programmed to receive at least one white point candidate and a spatial distribution from a first camera among a plurality of cameras. Each of the plurality of cameras may include circuitry configured to identify, based on a distribution of chromaticity coordinates, white point candidates and corresponding spatial distributions relative to a video output. The at least one processor may also be programmed to receive at least one white point candidate and a spatial distribution from a second camera among the plurality of cameras. The at least one processor may be further configured to compare the at least one white point candidate and the spatial distribution received from the first camera with the at least one white point candidate and the spatial distribution received from the second camera and determine, based on the comparing, a target color balance level for use by one or more of the plurality of cameras in adjusting a color balance setting. The at least one processor may be configured to distribute the target color balance level to the one or more of the plurality of cameras.

Embodiments of the present disclosure provide a non-transitory computer readable medium containing instructions that when executed by at least one processor cause the at least one processor to perform operations for adjusting color balance across multiple cameras. The operations may comprise generating, using each camera of a plurality of cameras, a plurality of video outputs. Each video output may be representative of at least a portion of a meeting environment. The operations may further comprise determining, based on a distribution of chromaticity coordinates of each video output, at least one white point candidate of each video output and a spatial distribution corresponding to the at least one white point candidate. Further, the operations may comprise comparing at least one white point candidate and spatial distribution received from a first camera with at least one white point candidate and spatial distribution received from a second camera and determining, based on the comparing, a target color balance level for use by one or more of the plurality of cameras in adjusting a color balance setting. The operations may further comprise distributing the target color balance level to the one or more of the plurality of cameras.

Embodiments of the present disclosure provide a multi-camera videoconferencing system comprising a plurality of cameras and a multi-camera exposure controller. Each camera of the plurality of cameras may be configured to generate a video output representative of a meeting environment. The multi-camera exposure controller may be located on board one or more cameras in the multi-camera system or may be located remote relative to one or more cameras in the multi-camera system. The multi-camera exposure controller may be configured to receive, from a first camera among the plurality of cameras, a first exposure value determined for the first camera and to receive, from a second camera among the plurality of cameras, a second exposure value determined for the second camera. The controller may be further configured to determine a global exposure value based on the received first and second exposure values and distribute the global exposure value to the plurality of cameras for us by one or more of the plurality of cameras in adjusting an exposure setting associated with the one or more of the plurality of cameras.

Embodiments of the present disclosure provide a non-transitory computer readable medium containing instructions that when executed by at least one processor cause the at least one processor to perform operations for adjusting light exposure across a plurality of cameras. The operations may comprise receiving, from a first camera among the plurality of cameras, a first exposure value determined for the first camera and receiving, from a second camera among the plurality of cameras, a second exposure value determined for the second camera. The operations may further comprise determining a global exposure value based on the received first and second exposure values and distributing the global exposure value to the plurality of cameras for use by one or more of the plurality of cameras in adjusting an exposure setting associated with the one or more of the plurality of cameras.

### BRIEF DESCRIPTION OF THE DRAWINGS

The accompanying drawings, which are incorporated in and constitute a part of this specification, illustrate disclosed embodiments and, together with the description, serve to explain the disclosed embodiments. The particulars shown are by way of example and for purposes of illustrative discussion of embodiments of the present disclosure. The description taken with the drawings makes apparent to those skilled in the art how embodiments of the present disclosure may be practiced.

FIG. 1 is a diagrammatic representation of an example of a multi-camera system, consistent with some embodiments of the present disclosure.

FIG. 2 is a diagrammatic representation of a camera including a video processing unit, consistent with some embodiments of the present disclosure.

FIG. 3 is an illustration of a CIE 1931 RGB color space, consistent with some embodiments of the present disclosure.

FIG. 4 is an illustration of an example histogram of color temperature distribution, consistent with some embodiments of the present disclosure.

FIG. 5 is a diagrammatic representation of the transmitting and receiving of white point candidates and spatial distributions between cameras, consistent with some embodiments of the present disclosure.

FIG. 6A is an illustration of an example distribution of patches from a first camera over a CIE gamut, consistent with some embodiments of the present disclosure.

FIG. 6B is an illustration of an example histogram of patches in color temperature corresponding to the distribution shown in FIG. 6A, consistent with some embodiments of the present disclosure.

FIG. 6C is an illustration of an example distribution of patches over a CIE gamut after correction for a white point as illustrated in FIG. 6B, consistent with some embodiments of the present disclosure.

FIG. 7A is an illustration of an example distribution of patches from a second camera over a CIE gamut, consistent with some embodiments of the present disclosure.

FIG. 7B is an illustration of an example histogram of patches in color temperature corresponding to the distribution shown in FIG. 7A, consistent with some embodiments of the present disclosure.

FIG. 7C is an illustration of an example distribution of patches over a CIE gamut after correction for a white point as illustrated in FIG. 7B, consistent with some embodiments of the present disclosure.

FIGS. 8A and 8B illustrate example patch distributions for the cameras associated with FIGS. 6A-6C and FIGS. 7A-7C, respectively, after color (or white balance) correction, consistent with some embodiments of the present disclosure.

FIG. 9 is a flowchart of an example method/process of adjusting color balance across multiple cameras, consistent with some embodiments of the present disclosure.

FIG. 10 is a flowchart of an example method/process of adjusting light exposure across a plurality of cameras, consistent with some embodiments of the present disclosure.

FIG. 11 is a flowchart of another example method/process of adjusting light exposure across a plurality of cameras, consistent with some embodiments of the present disclosure.

### DETAILED DESCRIPTION

The present disclosure provides video conferencing systems, and camera systems for use in video conferencing. Thus, where a camera system is referred to herein, it should be understood that this may alternatively be referred to as a video conferencing system, a video conferencing camera system, or a camera system for video conferencing. As used herein, the term “video conferencing system” refers to a system, such as a video conferencing camera, that may be used for video conferencing, and may be alternatively referred to as a system for video conferencing. The video conferencing system need not be capable of providing video conferencing capabilities on its own, and may interface with other devices or systems, such as a laptop, PC, or other network-enabled device, to provide video conferencing capabilities.

Video conferencing systems/camera systems in accordance with the present disclosure may comprise at least one camera and a video processor for processing video output generated by the at least one camera. The video processor may comprise one or more video processing units.

In accordance with embodiments of the present disclosure, a video conferencing camera may include at least one video processing unit. The at least one video processing unit may be configured to process the video output generated by the video conferencing camera. As used herein, a video processing unit may include any electronic circuitry designed to read, manipulate and/or alter computer-readable memory to create, generate or process video images and video frames intended for output (in, for example, a video output or video feed) to a display device. A video processing unit may include one or more microprocessors or other logic based devices configured to receive digital signals representative of acquired images. The disclosed video processing unit may include application-specific integrated circuits (ASICs), microprocessor units, or any other suitable structures for analyzing acquired images, selectively framing subjects based on analysis of acquired images, generating output video streams, etc.

In some cases, the at least one video processing unit may be located within a single camera. In other words, the video conferencing camera may comprise the video processing unit. In other embodiments, the at least one video processing unit may be located remotely from the camera, or may be distributed among multiple cameras and/or devices. For example, the at least one video processing unit may comprise more than one, or a plurality of, video processing units that are distributed among a group of electronic devices including one or more cameras (e.g., a multi-camera system), personal computers, a mobile devices (e.g., tablet, phone, etc.), and/or one or more cloud-based servers. Therefore, disclosed herein are video conferencing systems, for example video conferencing camera systems, comprising at least one camera and at least one video processing unit, as described herein. The at least one video processing unit may or may not be implemented as part of the at least one camera. The at least one video processing unit may be configured to receive video output generated by the one or more video conferencing cameras. The at least one video processing unit may decode digital signals to display a video and/or may store image data in a memory device. In some embodiments, a video processing unit may include a graphics processing unit. It should be understood that where a video processing unit is referred to herein in the singular, more than one video processing units is also contemplated. The various video processing steps described herein may be performed by the at least one video processing unit, and the at least one video processing unit may therefore be configured to perform a method as described herein, for example a video processing method, or any of the steps of such a method. Where a determination of a parameter, value, or quantity is disclosed herein in relation to such a method, it should be understood that the at least one video processing unit may perform the determination, and may therefore be configured to perform the determination.

Single camera and multi-camera systems are described herein. Although some features may be described with respect to single cameras and other features may be described with respect to multi-camera systems, it is to be understood that any and all of the features, embodiments, and elements herein may pertain to or be implemented in both single camera and multi-camera systems. For example, some features, embodiments, and elements may be described as pertaining to single camera systems. It is to be understood that those features, embodiments, and elements may pertain to and/or be implemented in multi-camera systems.

Furthermore, other features, embodiments, and elements may be described as pertaining to multi-camera systems. It is also to be understood that those features, embodiments, and elements may pertain to and/or be implemented in single camera systems.

Embodiments of the present disclosure include multi-camera systems. As used herein, multi-camera systems may include two or more cameras that are employed in an environment, such as a meeting environment, and that can simultaneously record or broadcast one or more representations of the environment. The disclosed cameras may include any device including one or more light-sensitive sensors configured to capture a stream of image frames. Examples of cameras may include, but are not limited to, Huddly® L1 or S1 cameras, Huddly® IQ cameras, digital cameras, smart phone cameras, compact cameras, digital single-lens reflex (DSLR) video cameras, mirrorless cameras, action (adventure) cameras, 360-degree cameras, medium format cameras, webcams, or any other device for recording visual images and generating corresponding video signals.

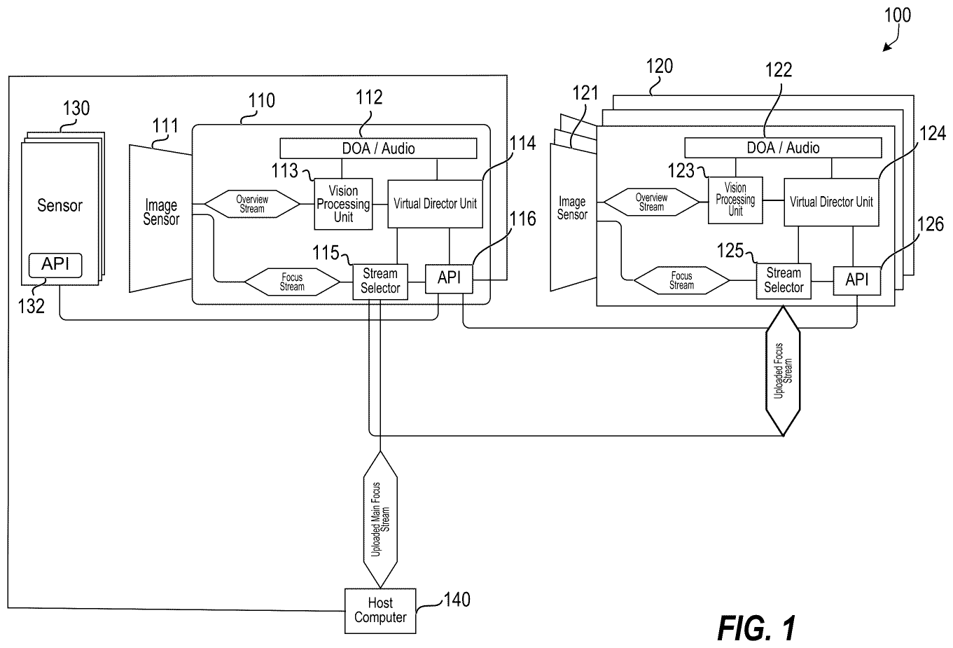

Referring to FIG. 1, a diagrammatic representation of an example of a multi-camera system 100, consistent with some embodiments of the present disclosure, is provided. Multi-camera system 100 may include a main camera 110, one or more peripheral cameras 120, one or more sensors 130, and a host computer 140. In some embodiments, main camera 110 and one or more peripheral cameras 120 may be of the same camera type such as, but not limited to, the examples of cameras discussed above. Furthermore, in some embodiments, main camera 110 and one or more peripheral cameras 120 may be interchangeable, such that main camera 110 and the one or more peripheral cameras 120 may be located together in a meeting environment, and any of the cameras may be selected to serve as a main camera. Such selection may be based on various factors such as, but not limited to, the location of a speaker, the layout of the meeting environment, a location of an auxiliary item (e.g., whiteboard, presentation screen, television), etc. In some cases, the main camera and the peripheral cameras may operate in a master-slave arrangement. For example, the main camera may include most or all of the components used for video processing associated with the multiple outputs of the various cameras included in the multi-camera system. In other cases, the system may include a more distributed arrangement in which video processing components (and tasks) are more equally distributed across the various cameras of the multi-camera system. Further, in some embodiments, the video processing components may be located remotely relative to the various cameras of the multi-camera system such as on an adapter, computer, or server/network.

As shown in FIG. 1, main camera 110 and one or more peripheral cameras 120 may each include an image sensor 111, 121. Furthermore, main camera 110 and one or more peripheral cameras 120 may include a directional audio (DOA/Audio) unit 112, 122. DOA/Audio unit 112, 122 may detect and/or record audio signals and determine a direction that one or more audio signals originate from. In some embodiments, DOA/Audio unit 112, 122 may determine, or be used to determine, the direction of a speaker in a meeting environment. For example, DOA/Audio unit 112, 122 may include a microphone array that may detect audio signals from different locations relative to main camera 110 and/or one or more peripheral cameras 120. DOA/Audio unit 112, 122 may use the audio signals from different microphones and determine the angle and/or location that an audio signal (e.g., a voice) originates from. Additionally, or alternatively, in some embodiments, DOA/Audio unit 112, 122 may distinguish between situations in a meeting environment where a meeting participant is speaking, and other situations in a meeting environment where there is silence. In some embodiments, the determination of a direction that one or more audio signals originate from and/or the distinguishing between different situations in a meeting environment may be determined by a unit other than DOA/Audio unit 112, 122, such as one or more sensors 130.

Main camera 110 and one or more peripheral cameras 120 may include a vision processing unit 113, 123. Vision processing unit 113, 123 may include one or more hardware accelerated programmable convolutional neural networks with pretrained weights that can detect different properties from video and/or audio. For example, in some embodiments, vision processing unit 113, 123 may use vision pipeline models (e.g., machine learning models) to determine the location of meeting participants in a meeting environment based on the representations of the meeting participants in an overview stream. As used herein, an overview stream may include a video recording of a meeting environment at the standard zoom and perspective of the camera used to capture the recording, or at the most zoomed out perspective of the camera. In other words, the overview shot or stream may include the maximum field of view of the camera. Alternatively, an overview shot may be a zoomed or cropped portion of the full video output of the camera, but may still capture an overview shot of the meeting environment. In general, an overview shot or overview video stream may capture an overview of the meeting environment, and may be framed to feature, for example, representations of all or substantially all of the meeting participants within the field of view of the camera, or present in the meeting environment and detected or identified by the system, e.g. by the video processing unit(s) based on analysis of the camera output. A primary, or focus stream may include a focused, enhanced, or zoomed in, recording of the meeting environment. In some embodiments, the primary or focus stream may be a sub-stream of the overview stream. As used herein, a sub-stream may pertain to a video recording that captures a portion, or sub-frame, of an overview stream. Furthermore, in some embodiments, vision processing unit 113, 123 may be trained to be not biased on various parameters including, but not limited to, gender, age, race, scene, light, and size, allowing for a robust meeting or videoconferencing experience.

As shown in FIG. 1, main camera 110 and one or more peripheral cameras 120 may include virtual director unit 114, 124. In some embodiments, virtual director unit 114, 124 may control a main video stream that may be consumed by a connected host computer 140. In some embodiments, host computer 140 may include one or more of a television, a laptop, a mobile device, or projector, or any other computing system. Virtual director unit 114, 124 may include a software component that may use input from vision processing unit 113, 123 and determine the video output stream, and from which camera (e.g., of main camera 110 and one or more peripheral cameras 120), to stream to host computer 140. Virtual director unit 114, 124 may create an automated experience that may resemble that of a television talk show production or interactive video experience. In some embodiments, virtual director unit 114, 124 may frame representations of each meeting participant in a meeting environment. For example, virtual director unit 114, 124 may determine that a camera (e.g., of main camera 110 and/or one or more peripheral cameras 120) may provide an ideal frame, or shot, of a meeting participant in the meeting environment. The ideal frame, or shot, may be determined by a variety of factors including, but not limited to, the angle of each camera in relation to a meeting participant, the location of the meeting participant, the level of participation of the meeting participant, or other properties associated with the meeting participant. More non-limiting examples of properties associated with the meeting participant that may be used to determine the ideal frame, or shot, of the meeting participant may include: whether the meeting participant is speaking, the duration of time the meeting participant has spoken, the direction of gaze of the meeting participant, the percent that the meeting participant is visible in the frame, the reactions and body language of the meeting participant, or other meeting participants that may be visible in the frame.

Multi-camera system 100 may include one or more sensors 130. Sensors 130 may include one or more smart sensors. As used herein, a smart sensor may include a device that receives input from the physical environment and uses built-in or associated computing resources to perform predefined functions upon detection of specific input, and process data before transmitting the data to another unit. In some embodiments, one or more sensors 130 may transmit data to main camera 110 and/or one or more peripheral cameras 120, or to the at least one video processing units. Non-limiting examples of sensors may include level sensors, electric current sensors, humidity sensors, pressure sensors, temperature sensors, proximity sensors, heat sensors, flow sensors, fluid velocity sensors, and infrared sensors. Furthermore, non-limiting examples of smart sensors may include touchpads, microphones, smartphones, GPS trackers, echolocation sensors, thermometers, humidity sensors, and biometric sensors. Furthermore, in some embodiments, one or more sensors 130 may be placed throughout the meeting environment. Additionally, or alternatively, the sensors of one or more sensors 130 may be the same type of sensor, or different types of sensors. In other cases, sensors 130 may generate and transmit raw signal output(s) to one or more processing units, which may be located on main camera 110 or distributed among two or more cameras including in the multi-camera system. Processing units may receive the raw signal output(s), process the received signals, and use the processed signals in providing various features of the multi-camera system (such features being discussed in more detail below).

As shown in FIG. 1, one or more sensors 130 may include an application programming interface (API) 132. Furthermore, as also shown in FIG. 1, main camera 110 and one or more peripheral cameras 120 may include APIs 116, 126. As used herein, an API may pertain to a set of defined rules that may enable different applications, computer programs, or units to communicate with each other. For example, API 132 of one or more sensors 130, API 116 of main camera 110, and API 126 of one or more peripheral cameras 120 may be connected to each other, as shown in FIG. 1, and allow one or more sensors 130, main camera 110, and one or more peripheral cameras 120 to communicate with each other. It is contemplated that APIs 116, 126, 132 may be connected in any suitable manner such as—but not limited to—via Ethernet, local area network (LAN), wired, or wireless networks. It is further contemplated that each sensor of one or more sensors 130 and each camera of one or more peripheral cameras 120 may include an API. In some embodiments, host computer 140 may be connected to main camera 110 via API 116, which may allow for communication between host computer 140 and main camera 110.

Main camera 110 and one or more peripheral cameras 120 may include a stream selector 115, 125. Stream selector 115, 125 may receive an overview stream and a focus stream of main camera 110 and/or one or more peripheral cameras 120, and provide an updated focus stream (based on the overview stream or the focus stream, for example) to host computer 140. The selection of the stream to display to host computer 140 may be performed by virtual director unit 114, 124. In some embodiments, the selection of the stream to display to host computer 140 may be performed by host computer 140. In other embodiments, the selection of the stream to display to host computer 140 may be determined by a user input received via host computer 140, where the user may be a meeting participant.

In some embodiments, an autonomous video conferencing (AVC) system is provided. The AVC system may include any or all of the features described above with respect to multi-camera system 100, in any combination. Furthermore, in some embodiments, one or more peripheral cameras and smart sensors of the AVC system may be placed in a separate video conferencing space (or meeting environment) as a secondary space for a video conference (or meeting). These peripheral cameras and smart sensors may be networked with the main camera and adapted to provide image and non-image input from the secondary space to the main camera. In some embodiments, the AVC system may be adapted to produce an automated television studio production for a combined video conferencing space based on input from cameras and smart sensors in both spaces.

In some embodiments, the AVC system may include a smart camera adapted with different degrees of field of view. For example, in a small video conference (or meeting) space with fewer smart cameras, the smart cameras may have a wide field of view (e.g., approximately 150 degrees). As another example, in a large video conference (or meeting) space with more smart cameras, the smart cameras may have a narrow field of view (e.g., approximately 90 degrees). In some embodiments, the AVC system may be equipped with smart cameras with various degrees of field of view, allowing optimal coverage for a video conferencing space.

Furthermore, in some embodiments, at least one image sensor of the AVC system may be adapted to zoom up to 10×, enabling close-up images of objects at a far end of a video conferencing space. Additionally, or alternatively, in some embodiments, at least one smart camera in the AVC system may be adapted to capture content on or about an object that may be a non-person item within the video conferencing space (or meeting environment). Non-limiting examples of non-person items include a whiteboard, a television (TV) display, a poster, or a demonstration bench. Cameras adapted to capture content on or about the object may be smaller and placed differently from other smart cameras in an AVC system, and may be mounted to, for example, a ceiling to provide effective coverage of the target content.

At least one audio device in a smart camera of an AVC system (e.g., a DOA audio device) may include a microphone array adapted to output audio signals representative of sound originating from different locations and/or directions around the smart camera. Signals from different microphones may allow the smart camera to determine a direction of audio (DOA) associated with audio signals and discern, for example, if there is silence in a particular location or direction. Such information may be made available to a vision pipeline and virtual director included in the AVC system. Thus, in some embodiments, machine learning models as disclosed herein may include an audio model that provides both direction of audio (DOA) and voice activity detection (VAD) associated with audio signals received from, for example, a microphone array, to provide information about when someone speaks. In some embodiments, a computational device with high computing power may be connected to the AVC system through an Ethernet switch. The computational device may be adapted to provide additional computing power to the AVC system. In some embodiments, the computational device may include one or more high performance CPUs and GPUs and may run parts of a vision pipeline for a main camera and any designated peripheral cameras.

In some embodiments, by placing multiple wide field of view single lens cameras that collaborate to frame meeting participants in a meeting environment as the meeting participants engage and participate in the conversation from different camera angles and zoom levels, the multi-system camera may create a varied, flexible and interesting experience. This may give far end participants (e.g., participants located further from cameras, participants attending remotely or via video conference) a natural feeling of what is happening in the meeting environment.

Disclosed embodiments may include a multi-camera system comprising a plurality of cameras. Each camera may be configured to generate a video output stream representative of a meeting environment. Each video output stream may feature one or more meeting participants present in the meeting environment. In this context, “featured” means that the video output stream includes or features representations of the one or more meeting participants. For example, a first representation of a meeting participant may be included in a first video output stream from a first camera included in the plurality of cameras, and a second representation of a meeting participant may be included in a second video output stream from a second camera included in the plurality of cameras. As used herein, a meeting environment may pertain to any space where there is a gathering of people interacting with one another. Non-limiting examples of a meeting environment may include a board room, classroom, lecture hall, videoconference space, or office space. As used herein, a representation of a meeting participant may pertain to an image, video, or other visual rendering of a meeting participant that may be captured, recorded, and/or displayed to, for example, a display unit. A video output stream, or a video stream, may pertain to a media component (may include visual and/or audio rendering) that may be delivered to, for example, a display unit via wired or wireless connection and played back in real time. Non-limiting examples of a display unit may include a computer, tablet, television, mobile device, projector, projector screen, or any other device that may display, or show, an image, video, or other rendering of a meeting environment.

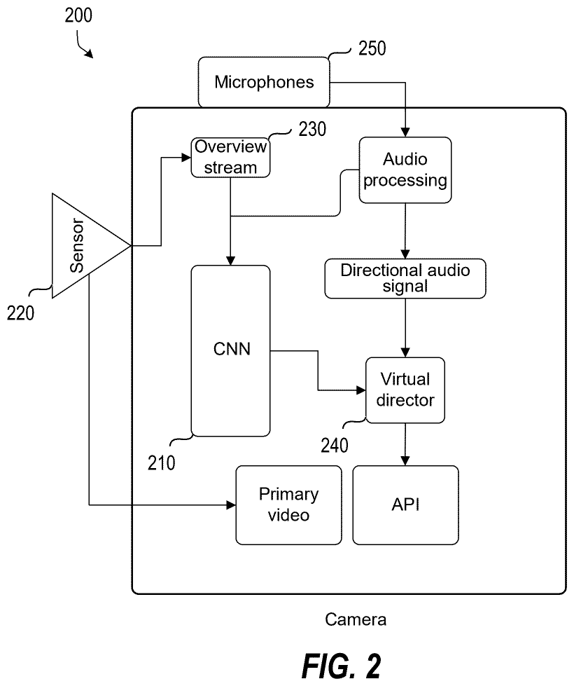

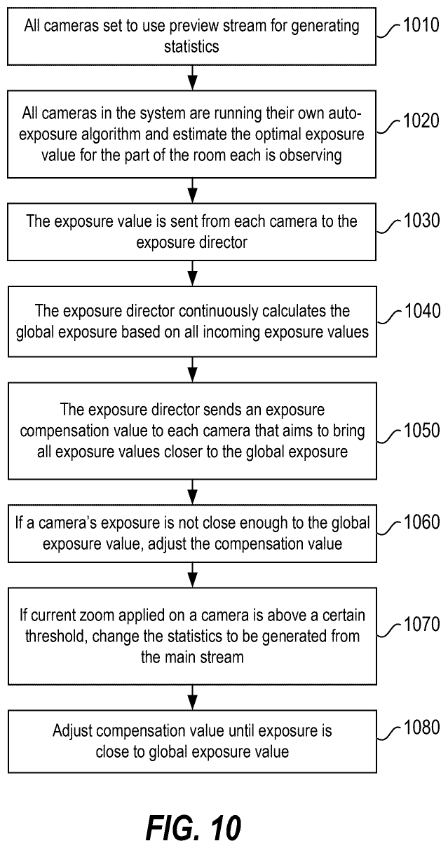

FIG. 2 is a diagrammatic representation of a camera 200 including a video processing unit 210. As shown in FIG. 10, a video processing unit 210 may process the video data from a sensor 220. Furthermore, video processing unit 210 may split video streams, or video data, into two streams. These streams may include an overview stream 230 and an enhanced and zoomed video stream (not shown). Using specialized hardware and software, the camera 300 may detect the location of meeting participants using a wide-angle lens (not shown) and/or high-resolution sensor, such as sensor 220. Furthermore, in some embodiments, camera 200 may determine—based on head direction(s) of meeting participants—who is speaking, detect facial expressions, and determine where attention is centered based on head direction(s). This information may be transmitted to a virtual director 240, and the virtual director 240 may determine an appropriate video settings selection for video stream(s).

Embodiments of the present disclosure may provide multi-camera videoconferencing systems or non-transitory computer readable media containing instructions for adjusting color balance across multiple cameras. Some embodiments may involve machine language vision/audio pipelines that can detect people, objects, speech, movement, posture, canvas enhancement, documents, and depth in a videoconferencing space. In some embodiments a virtual director unit (or component) may use the machine language vision/audio and previous events in the videoconference to determine particular portions of an image or video output (from one or more cameras) to place in a composite video stream. The virtual director unit (or component) may determine a particular layout for the composite video stream.

Further, in some embodiments, an illuminant estimation component (or unit) may be implemented on one or more cameras in the multi-camera system. It is further contemplated that the illuminant estimation component may be implemented remotely relative to the cameras of the multi-camera system (e.g., on a user computer, network/server, adapter, etc.). The illuminant estimation component may calculate illuminant candidate white points, intensity, spatial distribution, and/or other illuminant properties. The illuminant estimation component may, in some embodiments, calculate other low-level image statistics and features related to illuminants.

A color and white balance agent (e.g., color balance unit) may be implemented on one or more cameras in the multi-camera system. It is contemplated that the color and white balance agent may be implemented remotely relative to the cameras of the multi-camera system (e.g., on a user computer, network/server, adapter, etc.). The color and white balance agent may combine illuminant properties from illuminant estimation components and, in some embodiments, machine language vision features and video composition, to determine balanced optimal color and white balance setting for one or more cameras in the multi-camera system. Knowledge of the composition and feedback to the virtual director may allow optimizing certain views over others. In some embodiments, the color and white balance agent may provide a guided white balance decision. The guided white balance decision may allow different color and white balance agents to converge toward a common shared white balance decision. This may eliminate the need for expensive between-camera color calibration.

Embodiments of the present disclosure relate to systems and methods for multi-camera white balance. Instead of directly using external white point candidates estimated on other cameras to determine the white balance on a local camera, external white point candidates may be used indirectly to guide the white balance decision on each camera. Further, in some embodiments, only white point candidates estimated locally may be used directly. This may reduce the need for multi-camera calibration while still providing a synchronized white balance.

In some embodiments, each camera of a multi-camera system may collect image statistics, which may be mapped approximately to an absolute color space (e.g., CIE 1931) and determine white point candidates in the color space or a reduced subspace (e.g., color temperatures on a black body curve). White point candidates and other additional information (e.g., spatial distribution) may be shared between cameras which may, in turn, each determine a final white balance. White point candidates from other cameras may boost or inhibit candidates determined locally.

The raw image captured by an image sensor may be divided into areas called patches. Each patch may define a certain group of unique pixels. In some embodiments, patches may overlap and may be of different sizes and shapes in different parts of an image. Color statistics from the patches may be considered a low-resolution version of the image itself.

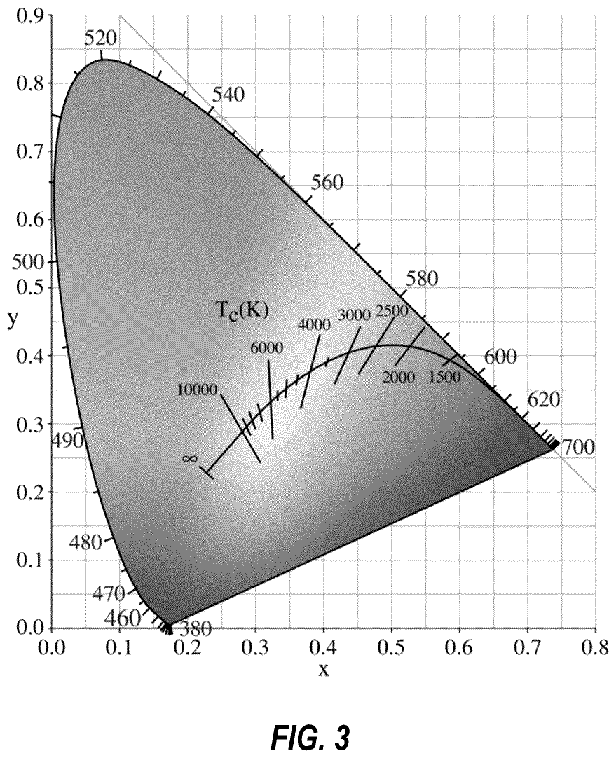

As discussed above, image statistics collected by one or more cameras of the multi-camera system discussed herein may be mapped approximately to an absolute color space, such as the CIE 1931 RGB color space shown in FIG. 3. The locus defined by Tc(K) represents the black body curve in the x-y color space defined by CIE. The locus represents the color of an ideal black-body radiator which produces light as a result of its temperature increased to k degrees (in Kelvin). It is a convenient assumption to consider the color of any light source to follow the Planckian locus. Such an assumption is not far from reality for most conventional light sources.

The raw RGB color of any pixel from an image, if converted to the CIE color space, may be represented by an (x,y) location. The color of each pixel in a camera may be a combination of an illumination color and a color of background. Accordingly, in some embodiments, the (x,y) location for a patch in CIE color space may hold information for color of illumination and background color of that patch. One of the goals of white point estimation methods (such as those discussed herein) may be to deduce the illumination color based on a distribution of (x,y) points.

For example, for a white background color, the (x,y) location may represent the illumination color. Planckian locus may be assumed to represent coordinate of possible illuminations. In some embodiments of methods disclosed herein, patch locations may be projected onto the Planckian locus, where their distribution may indicate the distribution of color temperature of the patches in an image.

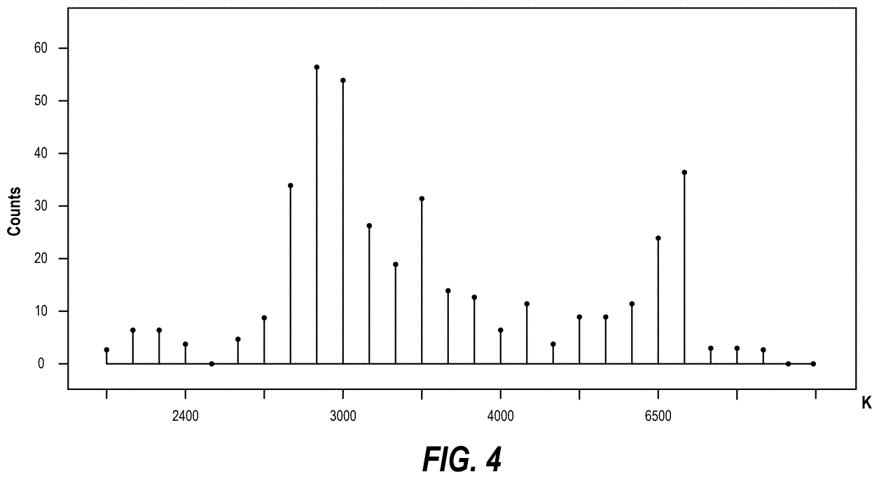

A histogram, such as the histogram shown in FIG. 4, may be calculated to approximate such a distribution. With reference to FIG. 4, each bin in the histogram may represent a range of color temperatures, and the values for each bin may indicate how many patches exist in the image with a certain color temperature (counts). Said another way, the x-axis may represent color temperature in Kelvin and the y-axis may represent a count of the number of patches in an image with a particular color temperature. The peaks in the histogram may represent likely candidates for illumination color temperatures. For example, as shown in FIG. 4, the histogram peaks at around 3000 K and 6500 K. These may be considered white point candidates. These white point candidates and their corresponding spatial distributions may be shared between two (or more) cameras.

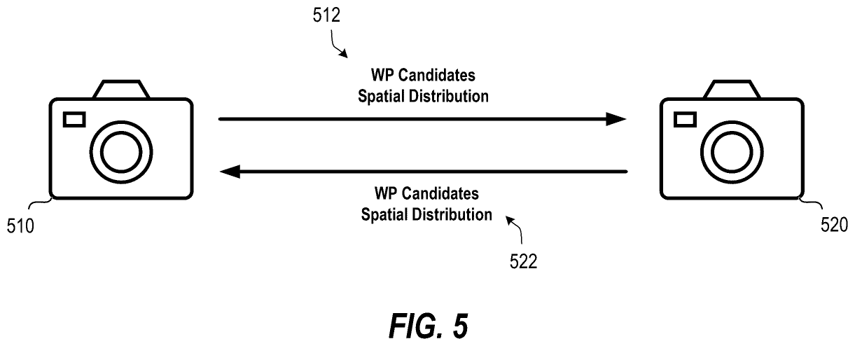

Differences in manufacturing of lens and camera sensors in each camera of the multi-camera system may result in differences in the color content of resulting images from each camera, even when the cameras are exposed to or capturing the same scene or environment. FIG. 5 is a diagrammatic representation of the flow of information between two cameras, in accordance with embodiments of the systems and methods discussed herein. Each camera may transmit its own white point candidate(s) and corresponding spatial distribution(s) and receive white point candidate(s) and corresponding spatial distribution(s) from another camera. For example, as shown in FIG. 5, camera 510 may send its white point (WP) candidate(s) and corresponding spatial distribution(s) 510 to camera 520. Similarly, camera 520 may send its WP candidate(s) and corresponding spatial distribution(s) 522 to camera 510. Upon receiving WP candidate(s) and corresponding spatial distribution(s) 522, camera 510 may associated its own WP candidate(s) with the received ones based on their spatial distribution(s). Thus, in some embodiments, the white point candidates from one camera may be used in another camera to boost (amplify) or hinder (reduce) possible white point candidates. This process may avoid directly influencing the color response of one camera by another one. Further, this process may avoid determinations/changes to white/color balance due to individual color differences between cameras. Thus, in some embodiments, the estimated white point in the cameras maybe brought closer to each other. Although it is shown that the WP candidate(s) and corresponding spatial distribution(s) may be sent directly to and received from each camera of the multi-camera system, it is contemplated that the WP candidate(s) and corresponding spatial distribution(s) may be sent to and received from a unit located remote from one or more of the cameras of the multi-camera system (e.g., a color balance unit may be located on a user/host computer, server/network, or separate adapter). Further, although FIG. 5 illustrates two cameras, it is to be understood that such a process may occur between any number of cameras in a multi-camera system.

There is a need for consistency between colors in an output image of a camera, because abrupt changes in colors may distract a user or otherwise influence the user's experience negatively. White point candidates detected at each frame may or may not be different from the previous (or preceding) frame. These slight differences maybe due to changes in illumination (particularly with sunlight) or other differences in an environment. A stable color adjustment method may smooth the possible changes in a white point, which may result from changing white point candidates. In a multi-camera set up, the white point of one camera may depend on the white point candidates that originate from other cameras (in addition to candidates internal to the camera). Accordingly, a stable white point estimate may need to smooth the changes in the received white point candidates, as well as the internal white point.

To provide the camera with a stable estimate, a Kalman filter based tracking method may be implemented to track changes in the white point candidates. For each white point candidate, the color temperature may be associated with a spatial gain and a depth value. Spatial gain may be calculated in a source camera (e.g., the camera that sends or transmits a white point candidate). Depth may be calculated in the receiving end (e.g., a camera or a separate unit/device) based on the number of times that a camera receives a specific white point candidate from a specific camera in the multi-camera system. Each white point candidate may contribute to an overall white point estimation based on its depth. For example, if a certain candidate is received more often, it may be assigned a higher gain in calculating the white point. Similarly, if a certain candidate disappears from the list of received candidates, the camera or other device receiving the white point candidates may still use the candidate but decrease (or decrement) the depth value of that white point candidate. If decreasing the depth value continues to zero, the tracking for that particular white point candidate may end. Implementing the systems and methods discussed herein, white point candidates may appear and disappear gradually during the calculation of a final white point.

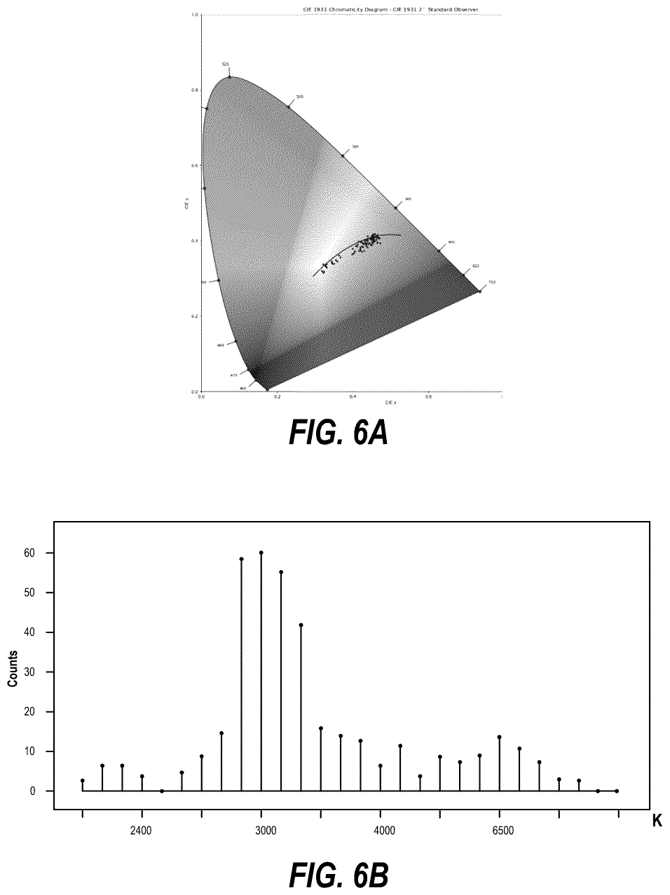

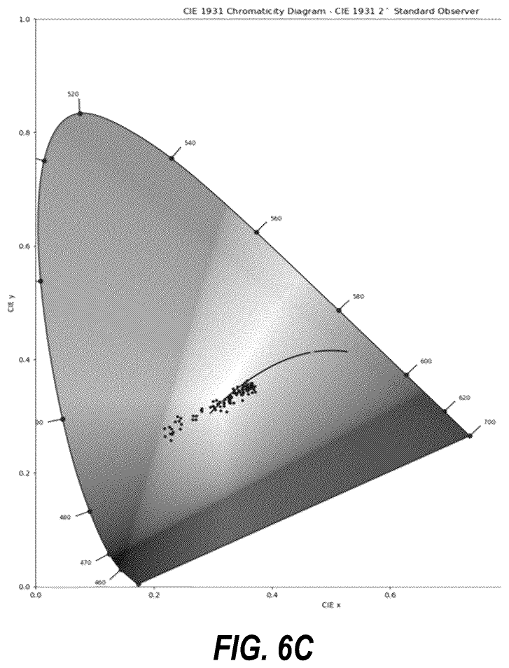

FIG. 6A illustrates an example distribution of (x,y) coordinates for a camera set up against a white wall that is illuminated by an indoor 2600 K and outdoor 6500 K light sources. As shown in FIG. 6A, patches may be clustered around points corresponding to the two light sources. FIG. 6B illustrates an example histogram corresponding to the distribution of FIG. 6A. As shown in FIGS. 6A and 6B, the main cluster of patches of the image(s) captured by the camera may have a color temperature near or around 2600 K. This may indicate that the camera faces the indoor light more than the outdoor light. As shown in the histogram of FIG. 6B, the resulting white point may have a color temperature of 3000 K. FIG. 6C illustrates an example distribution (x,y) coordinates for the camera used in FIG. 6A after correction for the white point in 3000 K.

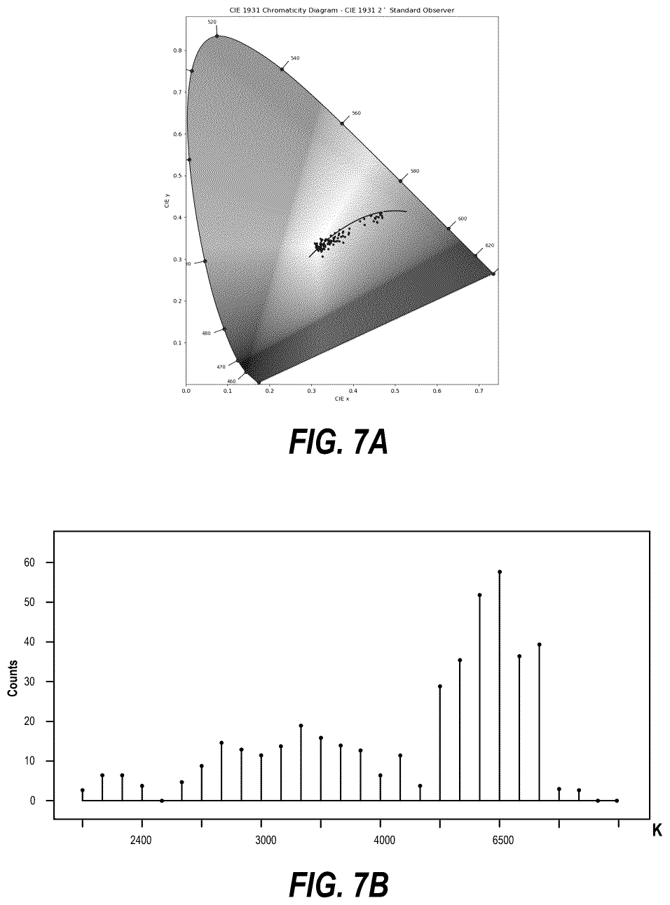

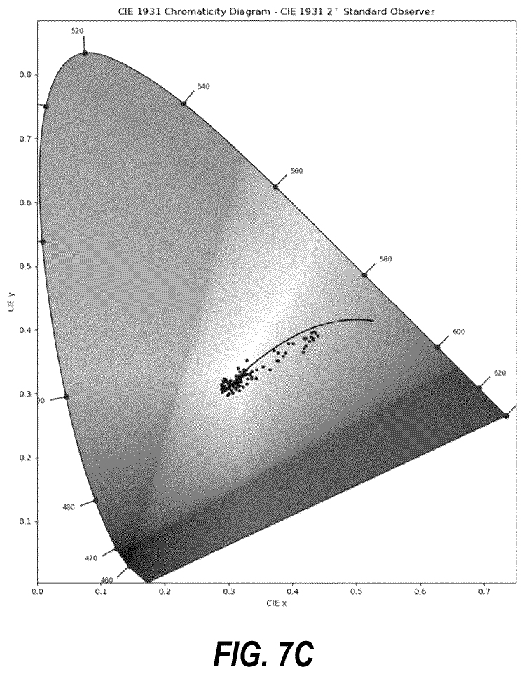

FIG. 7A illustrates an example distribution of (x,y) coordinates for another camera facing the same white wall as the camera discussed above with respect to FIG. 6A. FIG. 7B illustrates an example histogram corresponding to the distribution of FIG. 7A. As show in FIGS. 7A and 7B, the main cluster of patches of the image(s) captured by this camera may have a color temperature near or around 5400 K. This may indicate that the camera view covers more of the outdoor light source and less of the indoor lights. As shown in the histogram of FIG. 7B, the resulting white point may have a color temperature of 5400 K. FIG. 7C illustrates an example distribution (x,y) coordinates for the camera used in FIG. 7A after correction for the white point in 5400 K.

Due to the difference in view between the camera associated with FIGS. 6A-6C and the camera associated with FIGS. 7A-7C, the two cameras may produce white points that have a difference of 2400 K. Therefore, the image from the camera associated with FIGS. 6A-6C may be bluer compared to a more yellow image from the camera associated with FIGS. 7A-7C, despite both cameras facing the same white wall.

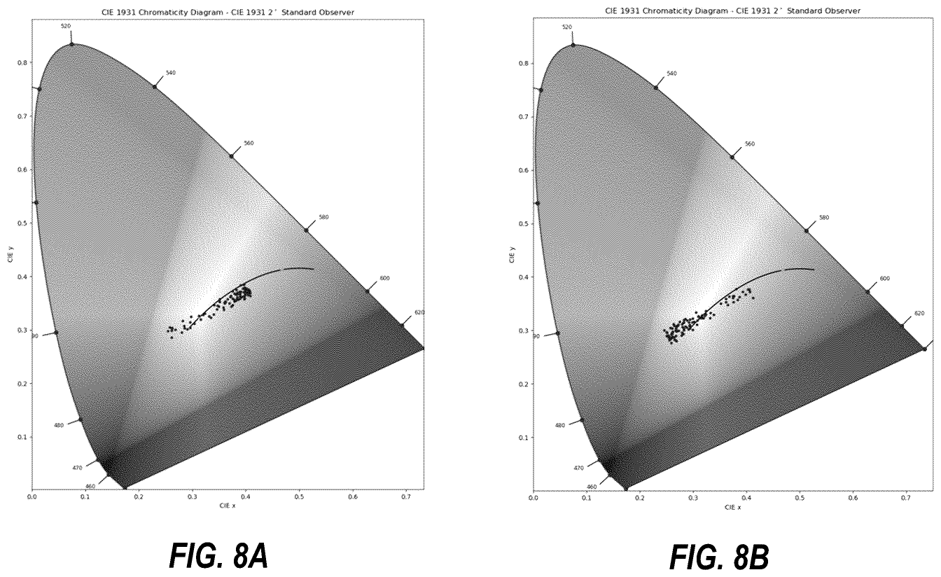

FIGS. 8A and 8B illustrate example patch distributions for the cameras associated with FIGS. 6A-6C and FIGS. 7A-7C, respectively, after color (or white balance) correction using systems and methods disclosed herein. The patch distributions shown in FIGS. 8A and 8B may be corrected to be more similar, as shown, and more coherent colors between the two cameras may be achieved.

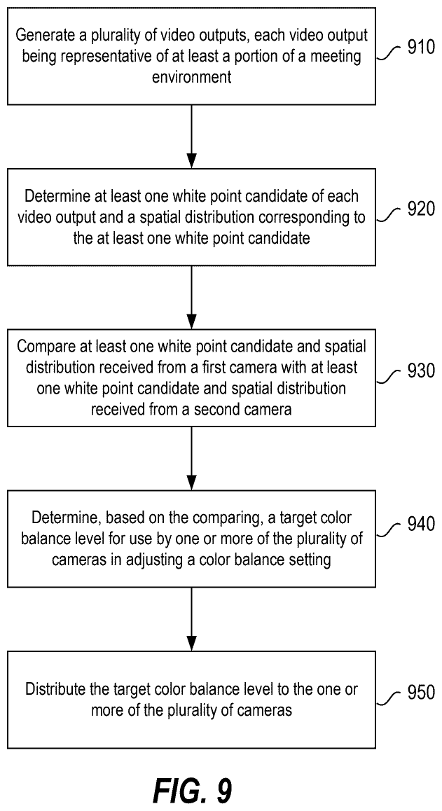

FIG. 9 illustrates an example flowchart for adjusting color balance across multiple cameras, consistent with embodiments of the present disclosure. The steps may be performed by a processor located on one or more cameras of a multi-camera system or located remotely relative to the cameras of the multi-camera system. Further, at least a portion of the steps may be performed by a color balance unit, and the color balance unit may include a processor. The color balance unit may be located on one or more cameras of the multi-camera system or may be located remotely relative to the cameras of the multi-camera system. For example, the color balance unit and/or processor located remotely may be located on a host/user computer, in a server/network computer, an adapter, etc. Further, the steps/operations discussed herein may also be performed in the cloud.

As shown in FIG. 9, one or more processors may generate a plurality of video outputs, each video output being representative of at least a portion of a meeting environment (step 910). As shown in 920, the one or more processors may determine at least one white point candidate of each video output and a spatial distribution corresponding to the at least one white point candidate. The at least one white point candidate and spatial distribution received from a first camera with at least one white point candidate and spatial distribution received from a second camera, as shown in step 930. The one or more processors may determine, based on the comparing, a target color balance level for use by one or more of a plurality of cameras (e.g., of the multi-camera system) in adjusting a color balance setting, as shown in step 940. As shown in step 950 of FIG. 9, the target color balance may be distributed to one or more of the plurality of cameras. The one or more of the plurality of cameras may adjust their color balance setting based on the target color balance.

Embodiments of the present disclosure may provide multi-camera videoconferencing systems or non-transitory computer readable media containing instructions for adjusting light exposure across a plurality of cameras. In some embodiments, a multi-camera exposure controller may be implemented, and the multi-camera exposure controller may control the exposure values for all cameras in the multi-camera system such that every shot (video output or portion of a video output) appears as if it were captured by the same camera. The multi-camera exposure controller may include a processor and may be located on one or more of the cameras of the multi-camera system. Alternatively, the multi-camera exposure controller may be located remotely relative to the cameras of the multi-camera system (e.g., on a host/user computer, network/server, adapter, in the cloud).

In some embodiments, the multi-camera exposure controller may determine one exposure value—or a range of exposure values—for all cameras in a multi-camera system. For example, each camera in a multi-camera system may run its own auto-exposure algorithm, and each camera may send its exposure value estimate to the multi-camera exposure controller. The multi-camera exposure controller may, in some embodiments, receive the exposure values from each camera of the multi-camera system and determine a target or global exposure value to be used by one or more cameras of the multi-camera system. The multi-camera exposure controller may determine the target or exposure value by calculating a median exposure value of the exposure values received from the cameras in the multi-camera system. Further, in some embodiments, the multi-camera exposure controller may select a camera that produces an exposure value that matches the target or global exposure value as the source camera. In some embodiments, following this process, the exposure value of the source camera may be sent to the other cameras in the multi-camera system such that they adjust to match the exposure value of the source camera.

In some embodiments, the multi-camera exposure controller may continuously (or periodically) calculate the target or global exposure value and select different source cameras based on each calculated target or global exposure value. Additionally, or alternatively, in some embodiments, the multi-camera exposure controller may detect when the lighting in an environment has changed significantly from when the exposure source camera was initially selected and then do another determination for a different source camera. In some embodiments, the source camera may remain the same.

In some embodiments, the multi-camera exposure controller may determine a global exposure value and allow each camera of the multi-camera system to deviate from that value by a particular amount (e.g., 1%, 2%, 5%, 10%). Allowing each camera to deviate from the global exposure value by a particular amount or percentage may improve the visibility of individuals sitting in areas of an environment where the illumination deviates from the average (e.g., individuals sitting in an area that has a large shadow). For example, a camera may pan to an individual sitting in an area that has a large shadow and slightly increase the exposure value a particular percentage above the determined global exposure value. The deviation from the global exposure value may be chosen as a particular percentage of the distance between the global exposure value and the camera's own estimated exposure value in a normalized linear scale.

Further, in some embodiments, one or more cameras of the multi-camera system may perform exposure convergence while not being streamed from. Said another way, each camera may determine its exposure value before or after its video output is streamed, allowing for continuous monitoring of changes in the environment and for adaptation to lighting changes without changing the exposure during streaming.

In some embodiments, a normalized exposure value range may be used such that the target or global exposure value may be converted between different types of cameras with different product specifications or exposure value ranges.

Additionally, or alternatively, an exposure compensation value may be implemented. The exposure compensation may change the brightness target for an exposure algorithm. For example, increasing the exposure compensation may make the image brighter, while decreasing it may make the image darker. Thus, in some embodiments, each camera of the multi-camera system may determine its optimal exposure value. The multi-camera exposure controller may then, using the exposure compensation, direct each camera to either brighten or darken its video output (or image)—depending on their individual optimal exposure value—such that all video outputs (or images) from the cameras appear to have similar light exposure.

FIG. 10 depicts a flowchart for adjusting light exposure across a plurality of cameras. As shown in FIG. 10, each camera may be set to use a preview stream for generating statistics (e.g., statistics associated with a particular lighting of a portion of an environment) (step 1010). Further, each camera in the multi-camera system may run their own auto-exposure algorithm and estimate the optimal exposure value for the portion of the environment that is captured by camera (step 1020). The exposure value may then be sent from each camera to an exposure director or multi-camera exposure controller (step 1030). The exposure director or multi-camera exposure controller may calculate the global exposure value based on all incoming exposure values from each camera of the multi-camera system (step 1040). The global exposure value may be a calculated median of the incoming exposure values. Further, the exposure director or multi-camera exposure controller may send an exposure compensation value to each camera (step 1050). The exposure compensation value may aim to bring all exposure values of the cameras closer to the calculated global exposure value. In some embodiments, if a particular camera's exposure is not close enough to the global exposure value, the compensation value may be adjusted (step 1060). In some embodiments, different zoom levels of each camera may provide uneven illumination. Thus, additionally, or alternatively, in some embodiments, if a current zoom applied on a camera is above a certain threshold, the statistics of that camera may be changed to be generated from a main stream (step 1070). The compensation value may be adjusted until the exposure of the camera is close to the calculated global exposure value (step 1080).

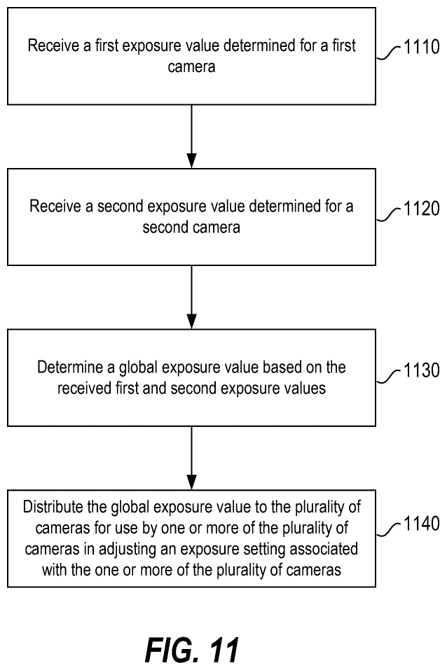

FIG. 11 depicts a flowchart of another example process for adjusting light exposure across a plurality of cameras, consistent with embodiments of the present disclosure. In some embodiments, a multi-camera exposure controller may be configured to perform the steps of the process. Additionally, or alternatively, in some embodiments, a processor may execute a non-transitory computer readable medium containing instructions for performing the step or operations of the process. As shown in FIG. 11, the processor may receive, from a first camera among a plurality of cameras, a first exposure value determined for the first camera (step 1110). The processor may further receive, from a second camera among the plurality of cameras, a second exposure value determined for the second camera (step 1120). The processor may be further configured to (step 1130) determine a global exposure value based on the received first and second exposure values and (step 1140) distribute the global exposure value to the plurality of cameras. The global exposure value may be used by one or more of the plurality of cameras in adjusting an exposure setting associated with the one or more of the plurality of cameras.

Other embodiments will be apparent from consideration of the specification and practice of the embodiments disclosed herein. It is intended that the specification and examples be considered as example only, with a true scope and spirit of the disclosed embodiments being indicated by the following claims.

For example, disclosed embodiments may include: a multi-camera videoconferencing system comprising: a plurality of cameras, each configured to generate a video output representative of a meeting environment; and a multi-camera exposure controller configured to: receive, from a first camera among the plurality of cameras, a first exposure value determined for the first camera; receive, from a second camera among the plurality of cameras, a second exposure value determined for the second camera; determine a global exposure value based on the received first and second exposure values; and distribute the global exposure value to the plurality of cameras for use by one or more of the plurality of cameras in adjusting an exposure setting associated with the one or more of the plurality of cameras.

In the multi-camera system, the exposure setting is adjusted to provide the global exposure value.

In the multi-camera system, the multi-camera exposure controller is further configured to determine a global exposure value range, wherein the adjusted exposure setting provides a particular global exposure value within the global exposure value range.

In the multi-camera system, the adjusting of the exposure setting occurs while the video output corresponding to the one or more of the plurality of cameras is not streaming.

In the multi-camera system, the multi-camera exposure controller is further configured to: receive a plurality of exposure values, each exposure value of the plurality of exposure values corresponding to a camera of the plurality of cameras; determine another global exposure value based on the received plurality of exposure values; and distribute the another global exposure value to the plurality of cameras for use by the plurality of cameras in adjusting the exposure setting associated with the one or more of the plurality of cameras.

In the multi-camera system, the exposure setting is adjusted to provide the another global exposure value.

In the multi-camera system, the another global exposure value is determined based on a calculated median of the plurality of exposure values.

In the multi-camera system, the multi-camera exposure controller is further configured to select a particular camera of the plurality of cameras as a source camera based on a proximity of each exposure value of the plurality of exposure values to the another global exposure value.

In the multi-camera system, the multi-camera exposure controller is further configured to determine another global exposure value range, wherein the adjusted exposure setting provides a particular global exposure value within the another global exposure value range.

As another example, disclosed embodiments may include: a non-transitory computer readable medium containing instructions that when executed by at least one processor cause the at least one processor to perform operations for adjusting light exposure across a plurality of cameras, the operations comprising: receiving, from a first camera among the plurality of cameras, a first exposure value determined for the first camera; receiving, from a second camera among the plurality of cameras, a second exposure value determined for the second camera; determining a global exposure value based on the received first and second exposure values; and distributing the global exposure value to the plurality of cameras for use by one or more of the plurality of cameras in adjusting an exposure setting associated with the one or more of the plurality of cameras.

In the non-transitory computer readable medium, the exposure setting is adjusted to provide the global exposure value.

In the non-transitory computer readable medium, the global exposure value is determined based on a calculated median of the first and second exposure values.

In the non-transitory computer readable medium, the operations further comprise determining a global exposure value range, wherein the adjusted exposure setting provides a particular global exposure value within the global exposure value range.

In the non-transitory computer readable medium, the adjusting of the exposure setting occurs while the video output corresponding to the one or more of the plurality of cameras is not streaming.

In the non-transitory computer readable medium, the operations further comprise: receiving a plurality of exposure values, each exposure value of the plurality of exposure values corresponding to a camera of the plurality of cameras; determining another global exposure value based on the received plurality of exposure values; and distributing the another global exposure value to the plurality of cameras for use by the plurality of cameras in adjusting the exposure setting associated with the one or more of the plurality of cameras.

In the non-transitory computer readable medium, the exposure setting is adjusted to provide the another global exposure value.

In the non-transitory computer readable medium, the another global exposure value is determined based on a calculated median of the plurality of exposure values.

In the non-transitory computer readable medium, the operations further comprise selecting a particular camera of the plurality of cameras as a source camera based on a proximity of each exposure value of the plurality of exposure values to the another global exposure value.

In the non-transitory computer readable medium, the operations further comprise determining another global exposure value range, wherein the adjusted exposure setting provides a particular global exposure value within the another global exposure value range.

Although many of the disclosed embodiments are described in the context of a camera system, a video conferencing system or the like, it should be understood that the present disclosure specifically contemplates, in relation to all disclosed embodiments, corresponding methods. More specifically methods corresponding to the actions, steps or operations performed by the video processing unit(s), as described herein, are disclosed. Thus, the present disclosure discloses video processing methods performed by at least one video processing unit, including any or all of the steps or operations performed by a video processing unit as disclosed herein. Furthermore, disclosed herein is at least one (or one or more) video processing units. Thus, it is specifically contemplated that at least one video processing unit may be claimed in any configuration as disclosed herein. The video processing unit(s) may be defined separately and independently of the camera(s) or other hardware components of the video conferencing system. Also disclosed herein is one or more computer readable media storing instructions that, when executed by one or more video processing units, cause the one or more video processing units to perform a method in accordance with the present disclosure (e.g., any or all of the steps or operations performed by a video processing unit, as described herein).

What is claimed is:

1. A multi-camera videoconferencing system for adjusting color balance across multiple cameras, the system comprising:
a color balance unit including at least one processor programmed to:
receive at least one white point candidate and a spatial distribution from a first camera among a plurality of cameras, wherein each of the plurality of cameras includes circuitry configured to identify, based on a distribution of chromaticity coordinates, white point candidates, and corresponding spatial distributions relative to a video output;
receive at least one white point candidate and a spatial distribution from a second camera among the plurality of cameras;
compare the at least one white point candidate and the spatial distribution received from the first camera with the at least one white point candidate and the spatial distribution received from the second camera;
determine, based on the comparing, a target color balance level for use by one or more of the plurality of cameras in adjusting a color balance setting; and
distribute the target color balance level to the one or more of the plurality of cameras.

2. The system of claim 1, wherein the distribution of chromaticity coordinates is determined by:
dividing the video output of each of the plurality of cameras into patches, each patch including at least one chromaticity coordinate, the video output including a plurality of chromaticity coordinates; and
generating the distribution of chromaticity coordinates based on the plurality of chromaticity coordinates.

3. The system of claim 2, wherein the at least one chromaticity coordinate is determined by:
obtaining raw color of pixels within each patch; and
converting the raw color to a chromaticity color space.

4. The system of claim 1, wherein, during the comparing, each at least one white point candidate is associated with a color temperature, the color temperature being associated with a spatial gain and a depth value.

5. The system of claim 4, wherein the depth value of each at least one white point candidate is calculated based on a number of times that the color balance unit receives a particular white point candidate.

6. The system of claim 5, wherein the particular white point candidate that is received a greater number of times is assigned a higher spatial gain.

7. The system of claim 5, wherein, based on the target color balance level, the first camera assigns more weight to a first white point candidate of the at least one white point candidate received from the first camera and the second camera assigns more weight to a second white point candidate of the at least one white point candidate received from the second camera.

8. The system of claim 2, wherein the at least one chromaticity coordinate includes information related to a color of illumination and a background color.

9. The system of claim 1, wherein the color balance unit is located on one or more of the plurality of cameras.

10. The system of claim 1, wherein the color balance unit is remotely located relative to the plurality of cameras.

11. A non-transitory computer readable medium containing instructions that when executed by at least one processor cause the at least one processor to perform operations for adjusting color balance across multiple cameras, the operations comprising:
generating, using each camera of a plurality of cameras, a plurality of video outputs, each video output being representative of at least a portion of a meeting environment;
determining, based on a distribution of chromaticity coordinates of each video output, at least one white point candidate of each video output and a spatial distribution corresponding to the at least one white point candidate;
comparing at least one white point candidate and spatial distribution received from a first camera with at least one white point candidate and spatial distribution received from a second camera
determining, based on the comparing, a target color balance level for use by one or more of the plurality of cameras in adjusting a color balance setting; and
distributing the target color balance level to the one or more of the plurality of cameras.

12. The non-transitory computer readable medium of claim 11, wherein the operations further comprise:
dividing each video output into patches, each patch including at least one chromaticity coordinate, each video output including a plurality of chromaticity coordinates; and
generating the distribution of chromaticity coordinates based on the plurality of chromaticity coordinates.

13. The non-transitory computer readable medium of claim 12, wherein the at least one chromaticity coordinate is determined by:
obtaining raw color of pixels within each patch; and
converting the raw color to a chromaticity color space.

14. The non-transitory computer readable medium of claim 11, wherein, during the comparing, each at least one white point candidate is associated with a color temperature, the color temperature being associated with a spatial gain and a depth value.

15. The non-transitory computer readable medium of claim 14, wherein the depth value of each at least one white point candidate is calculated based on a number of times that a particular white point candidate is received or identified.

16. The non-transitory computer readable medium of claim 15, wherein the particular white point candidate that is received or identified a greater number of times is assigned a higher spatial gain.

17. The non-transitory computer readable medium of claim 15, wherein, based on the target color balance level, the first camera assigns more weight to a first white point candidate of the at least one white point candidate received from the first camera and the second camera assigns more weight to a second white point candidate of the at least one white point candidate received from the second camera.

18. The non-transitory computer readable medium of claim 12, wherein the at least one chromaticity coordinate includes information related to a color of illumination and a background color.

19. The non-transitory computer readable medium of claim 11, wherein the determining the target color balance level is performed by a color balance unit located on one or more of the plurality of cameras.

20. The non-transitory computer readable medium of claim 11, wherein the determining the target color balance level is performed by a color balance unit remotely located relative to the plurality of cameras.

21. A multi-camera videoconferencing system, comprising:
a plurality of cameras, each camera being configured to generate video output representative of an environment;
a plurality of audio sources configured for distribution within the environment;
at least one video processing unit comprising one or more microprocessors, the video processing unit configured to:
analyze the video output from the plurality of cameras and aggregate audio signals from the plurality of audio sources based on one or more detected features of at least one subject represented in the video output,
wherein the analyzing includes using a machine learning algorithm to:
determine a direction of audio, the direction of audio including a direction the at least one subject is located at relative to the at least one camera; and
determine at least one audio signal containing speech, the at least one audio signal corresponding to the at least one subject,
wherein the at least one subject is a speaker; and
a color balance unit including at least one processor programmed to:
receive at least one white point candidate and a spatial distribution from a first camera among the plurality of cameras, wherein each of the plurality of cameras includes circuitry configured to identify, based on a distribution of chromaticity coordinates, white point candidates, and corresponding spatial distributions relative to the video output;
receive at least one white point candidate and a spatial distribution from a second camera among the plurality of cameras;
compare the at least one white point candidate and the spatial distribution received from the first camera with the at least one white point candidate and the spatial distribution received from the second camera;
determine, based on the comparing, a target color balance level for use by one or more of the plurality of cameras in adjusting a color balance setting; and
distribute the target color balance level to the one or more of the plurality of cameras.

22. The multi-camera system of claim 21, wherein the video output is one or more of an overview shot, a group shot, a speaker shot, or a listener shot.

23. The multi-camera system of claim 21, wherein at least one video processing unit includes a virtual director unit.

24. The multi-camera system of claim 21, wherein color balance unit is programmed to operate in real time.

25. The multi-camera system of claim 21, wherein the color balance unit is programmed to perform the comparison and determination automatically.
